(19) United States
(12) Patent Application Publication
(10) Pub. No.: US 2003/0077055 A1
(43) Pub. Date: Apr. 24, 2003

(54) Method of fabricating optical fiber preforms with high dopant concentration and good geometry

(75) Inventors: Richard P. Tumminelli, Ashland, MA (US); Ying Hua Zhang, Sharon, MA (US); Brian M. LaLiberte, Winchester, MA (US); Alexander Yusim, Boston, MA (US)

Correspondence Address: CHARLES E. WANDS, Messrs Allen Dyer, Doppelt, Milbrath & Gilchrist, 255 South Orange Avenue, 1401 Citrus Center, Box 3791, Orlando, FL, 32802-3791, US

(73) Assignee: JDS Uniphase Corporation, San Jose, CA

(21) Appl. No.: 10/073,697

(22) Filed: Feb. 11, 2002

Related U.S. Application Data
(60) Provisional application No. 60/345,133, filed on Oct. 19, 2001.

(51) Int. Cl. G02B 6/44; D02G 3/00

(52) U.S. Cl. 385/105; 428/375

(57) ABSTRACT

An optical fiber preform is made by modifying a conventional preform tube having a cladding zone and a core zone, before its thermal collapse normally followed by fiber drawing. The modification is accomplished by depositing, e.g. by MCVD, a thin protective layer of a light-transmissive material, e.g. silica, on the inner surface of the preform tube, over the core zone, before the collapse step. The material of the protective layer has a higher viscosity than the material of the core zone. The protective layer is deposited over the inner (core) zone of the preform tube and its thickness and composition is selected to prevent excessive viscosity drop of the typically alumina-doped core zone during the collapse step. The provision of the protective, viscosity-controlling protective layer is helpful in maintaining good roundness of the collapsed preform tube.

### CROSS-REFERENCE TO RELATED APPLICATION

This application claims priority from U.S. Provisional Application No 60/345,133 filed Oct. 19, 2001.

### FIELD OF THE INVENTION

The present invention relates to a method of fabrication of optical fiber preforms having relatively high dopant concentration and a relatively good geometry. More specifically, the invention deals with a method that improves control of the collapse of the preform tube to allow the fabrication of fibers with circular and concentric cores where the core dopant concentration is relatively high.

### BACKGROUND OF THE INVENTION

Optical fibers are commonly used in telecommunication. A typical telecommunication grade transmission fiber has a core and a cladding. The core is comprised mainly of silica (silicon oxide) doped with germania (germanium oxide) to raise the refractive index, and phosphorus to adjust the viscosity characteristics of the glass. The cladding material is comprised mostly of pure fused silica. An optical fiber is made from a preform which is a glass rod with a core and cladding material composition similar to that of the resulting fiber, but 200 to 500 times larger in diameter. The preform is subsequently drawn down to the size of the fiber.

There are many methods of fabricating the preforms, which include Outside Vapor Deposition (OVD), Vapor Phase Axial Deposition (VAD) and Modified Chemical Vapor Deposition (MCVD) to name a few. The former two are outside processes where the fabricated glass is deposited on a glass rod or mandrel in the form or submicron glass particles known as “soot”. A soot “boule” is formed and is subsequently sintered into a glass rod with the proper characteristics such as core NA, core size, etc.

The MCVD process consists of formation and deposition of the soot on an inner surface of a glass substrate tube. The deposited glass forms the core region and a part of the cladding region (“matched cladding”), with the largest part of the cladding being made up of the original substrate tube.

In the MCVD process, described for example in “An Overview of the Modified Chemical Vapor Deposition (MCVD) Process and Performance”, IEEE Jour. Quantum Elec., Vol QE-18, No. 4, April 1982, a preform substrate tube comprised of pure fused silica, SiO₂, is mounted on a glass-working lathe. The tube is held at both ends in the lathe chucks and fitted at one end with a rotation seal assembly which allows the delivery of glass precursor chemicals to the inside of the tube. The tube is rotated on the lathe. An oxy-hydrogen torch is provided on a carriage that is capable of traversing the length of the lathe bed and tube on the outside of the tube. The carriage is also equipped with an optical pyrometer that measures the outside temperature of the rotating tube, and the measurements are fed back to a controller to regulate the gas flow to the burner. In this way, the temperature of the rotating tube can be controlled to the desired value.

The glass and dopant forming precursor chemicals are delivered to the inside of the tube through the rotating seal. The precursors come from a chemical vapor delivery system which consists of temperature controlled vessels with the liquid precursor chemicals inside. Typical chemicals are SiCl₄, GeCl₄ and POCl₃, which are liquids at room temperature. A carrier gas, typically oxygen, is bubbled through the liquid, which vaporizes the material and carries it to the tube on the lathe. The flow rate of carrier gas, the temperature of the liquid precursor, and the total pressure of the system control the amount of material delivered to the tube. In order to deposit a layer of material inside the tube, the tube is rotated and brought to a predetermined temperature. As the chemical precursors flow to the hot zone, heated from the outside by the burner, they react to form oxides in the form of soot that travel down the tube and are deposited downstream.

The burner carriage is made to traverse at a predetermined speed, which accomplishes two tasks. First, it forms more soot as it travels, the soot depositing further downstream from the hot zone, and, it sinters the soot that has already been deposited into a uniform glass layer. As the torch traverses the entire length of the tube (a “pass”), a layer of glass material is deposited. Typically, a plurality of passes is made to deposit layers of glass with the desired composition. The composition can be changed by adjusting the carrier flow rates and/or the precursor temperatures. An example of the parameters used for a typical pass: precursor temperatures held at 20° C., SiCl₄ carrier flow rate=500 sccm, GeCl₄ carrier flow rate=200 sccm, POCl₃ carrier flow rate=100 sccm, tube temperature=1700° C., carriage traverse speed=100 mm/min, and inside tube pressure=2 mbar. This set of conditions would deposit glass at the rate of between 0.3 and 0.4 grams/minute. The total number of passes would be determined by how large a core deposition or core/cladding deposition is desired. The composition can be varied per pass, thereby altering the refractive index of the deposited material or altering other characteristics.

The process may include deposition of a so-called matched cladding, a concept known in the art. Typically, the equivalent of 2 to 3 core diameters of cladding is deposited. After deposition of the core and the matched cladding layers, the tube is collapsed to form a solid rod i.e. the preform. This is accomplished by increasing the temperature of the tube and subjecting the tube to a plurality of torch passes at the higher temperature, typically between 2000 and 2100° C. At this higher temperature, the stiff substrate tube becomes soft and shrinks in size, pass after pass, until it collapses to a solid rod.

To cite the “Overview of the Modified Chemical Vapor Deposition (MCVD) Process and Performance”, IEEE Jour. Quantum Elec., Vol QE-18, No. 4, April 1982, supra, the collapse rate of the tube is related to the viscosity of both the core and cladding materials, the surface tension of the materials and the pressure difference between the inside and outside of the collapsing tube. The collapse rate is roughly proportional to:

$$R α \frac{{P}_{o} - {P}_{i} + ( σ / {R}_{I D} ) + ( σ / {R}_{O D} )}{η ( T , C , t )}$$

where

R tube collapse rate

Pₒ outside pressure on the tube

Pᵢ=internal pressure in the tube

σ=surface tension of the glass

R_{ID,OD}=inside and outside radius of the tube.

η=viscosity of the glass as a function of temperature T, composition C and time t.

It has been found that if the collapse rate is too high, it can affect the dimensional stability of the final preform. The main effect is that the core tends to assume an elliptical shape in cross-section. This has been found to cause polarization mode dispersion (PMD) in the fiber, which has a deleterious effect on the eventual communication system. In order to lower the PMD contribution of the fiber, it is desirable to fabricate the preform such that its core ellipticity is as low as possible. Typically, ellipticity is defined as the difference between the major and minor axis of the ellipse divided by the minor axis. It is desirable to achieve ellipticity of less than 2%. A typical MCVD system is equipped with a diameter control system which measures the diameter of the tube and controls the inside pressure of the tube in order to control its diameter. Using this type of control, the collapse rate can be easily monitored and controlled so that core ellipticity is minimized.

The viscosity term in the above equation is largely determined by the viscosity of the innermost layers of the tube. The deposited core material is highly doped with alumina, and as a result, the viscosity term in the equation is lowered, thereby increasing the collapse rate which causes instability and loss of geometry control.

Pure silica has a relatively high viscosity compared to the deposited doped core glass.

In addition to basic transmission fiber, special optical fibers have become increasingly important to the telecommunication industry. They differ in many ways from standard transmission fibers, as they are designed to perform specific functions for various applications. For example, a photosensitive fiber is fabricated having a special core composition designed to enhance the photorefractive effect for making gratings in fiber. Other fibers may be designed to have special guiding characteristics (numerical aperture, NA, or mode field diameter, MFD) to be used as pigtail fibers, coupling fibers or other special uses.

One very important class of special fibers is rare earth doped fibers. The rare earth elements have interesting optical properties and are used as an optical gain medium for lasers and amplifiers. When doped into the core of an optical fiber, they provide optical gain for lasing or amplifying applications. In addition, because the gain medium is the core of an optical fiber, there are other benefits. The core provides tight confinement of the light, higher power density and high overlap of the pump light and the lasing or signal light. All these factors enhance the optical properties of the rare earths. In addition to the fibers' guiding properties, the presence of co-dopants with the rare earth has a significant effect on their performance.

In particular, erbium is a rare earth element with very useful properties. The performance of erbium-doped fiber is strongly dependent on the composition of dopants in the core. Along with the erbium, which must be uniformly incorporated into the core at a specific concentration, there is a co-dopant, alumina (Al₂O₃) that provides three very important properties. First, it acts as a homogenizing agent, which helps to incorporate the rare earth into the glass matrix without devitrification. Second, the alumina provides a large increase in the core's refractive index, thus it acts as the primary index raising dopant. Third, the presence of alumina broadens the fluorescence of the erbium atoms by causing Stark splitting of the energy levels. This provides for a broader gain profile, which is of importance for L band and extended L band amplifiers.

It is highly desirable to incorporate high concentrations of alumina with the erbium to provide broad fluorescence and high numerical aperture for tight power confinement which improves pump overlap and gain. Typical erbium doped fiber designs have a numerical aperture of approximately 0.25 corresponding to an alumina content of 10 wt % or greater, a germania content of 3 to 5 wt %, and an erbium concentration between 1000 and 2500 ppm depending on the application. The rest of the content of the core material is silica. Another result of high alumina doping is that it decreases the viscosity of the glass. As can be seen in equation 1, the collapse rate is inversely proportional to the viscosity of the glass. At these very high alumina concentrations, the core glass is literally fluid at the collapse temperature of the tube. This tends to destabilize the collapse, and makes it very difficult to control the core ellipticity. Another consequence of this destabilization is incorporation of bubbles in the core due to tube collapse in front of the hot zone, which traps bubbles along the length of the core. Both these phenomena lead to preforms with poor geometry.

### SUMMARY OF THE INVENTION

It is an object of this invention to overcome the deleterious effect that high dopant concentration has on preform geometry, without additional equipment and without compromising the quality of the deposited core material.

This and other objects are accomplished by depositing a protective layer of a light-transmissive material of higher viscosity than the deposited core material, on the inside surface of the preform tube after the deposition of core material and prior to the collapse phase of the preform tube.

The invention encompasses the preform tube made using the above method, as well as the preform obtained from the preform tube. In this aspect of the invention, the perform tube comprises an outer cladding zone, a core zone and a protective layer of a light transmissive material inside the core zone and contiguous with the core zone, the light transmissive material having a higher viscosity than the material of the core zone.

In one embodiment, the protective layer is the innermost layer of the preform tube.

In one embodiment, the protective layer is predominantly of silica, for example of substantially pure silica or of silica containing an amount of additives not affecting a desired viscosity gradient between the protective layer and the core material of the preform tube.

It will be understood that the term “preform tube” denotes a semi-product of the optical fiber preform manufacturing process, the preform also being a semi-product for making optical fibers.

Since the viscosity term is governed primarily by the innermost layer of glass, the deposited protective layer (e.g. silica layer) increases the viscosity term and tends to improve the control of the collapse to allow for good preform geometry. This effect is achieved without significantly changing the overall index profile of the preform or the dopant distribution by controlling the amount of silica deposition. This invention is preferable, but not exclusive, for preforms with dopant concentrations high enough to cause loss of collapse control.

### BRIEF DESCRIPTION OF THE DRAWINGS

In the drawings which illustrate the invention in more detail,

FIG. 1 illustrates concentration profiles of a conventional preform core doped with alumina, erbium oxide and germanium oxide, with the core being primarily silica with the dopant concentrations given, and without a protective layer of the invention;

FIG. 2 is a schematic sectional view of an optical fiber preform tube obtained using the method of the invention,

FIG. 3 illustrates a dopant concentration profile of a core of a preform where a substantially pure silica layer has been deposited using 15 sccm (standard cubic cm per minute) carrier flow rate through SiCl₄, and

FIG. 4 shows a profile analogous to that of FIG. 3 but with carrier flow rate of 25 sccm.

### DETAILED DESCRIPTION OF THE INVENTION

In comparative tests conducted to validate the invention, for prior art preforms with alumina concentrations of approximately 10 wt %, the best core ellipticity attained was 1.8%, with the typical values between 2 and 5%. After deposition of the silica layer, ellipticity values less than 1% were achieved when all other variables were in their normal range. The best result achieved was 0% ellipticity as measured with a preform analyzer where the core diameter was approximately 0.6 mm and the measurement resolution was 5 microns.

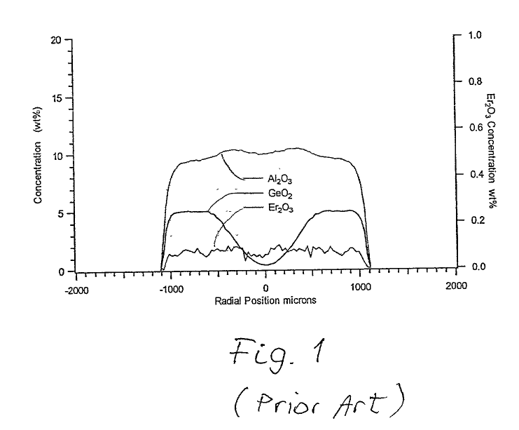

A typical prior art preform run would deposit the equivalent of a 2 mm core doped with alumina, erbium and germanium. A concentration profile is shown in FIG. 1 (prior art). It can be seen in FIG. 1 that the alumina and erbium oxide concentrations (alumina and germania concentrations shown on the left ordinate axis and erbium oxide concentration on the right axis) are relatively flat across the core diameter while the germania profile shows a distinctive central dip. This is well known in the industry and is due to germania burn-off during the collapse phase of the fabrication process. It does cause a refractive index dip, but not as large as it would be if only germania were present. The presence of the alumina, which does not bum off, reduces the index dip. For this preform, the core ellipticity was approximately 2%, which was the best result achieved in our tests using conventional technology.

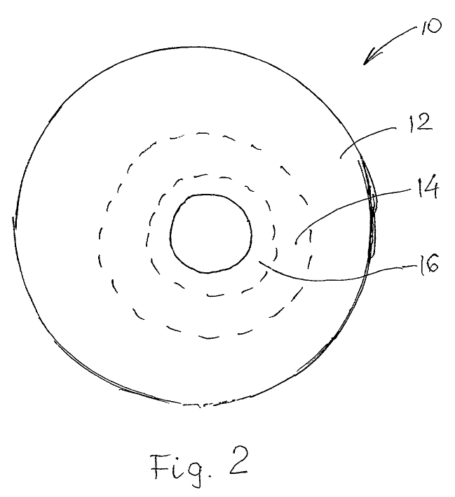

In FIG. 2, the preform tube is generally referenced as 10. It has a cladding region 12 composed of silica and a core region 14 composed of core material, specifically doped silica. The matched cladding is omitted for simplicity. The dopants are selected from alumina (for the reasons explained herein), germania and optionally erbium oxide. Other dopants may also be present depending on a specific use of the resulting fiber. The innermost layer 16 is the protective layer of the invention, a substantially pure silica in one embodiment of the invention.

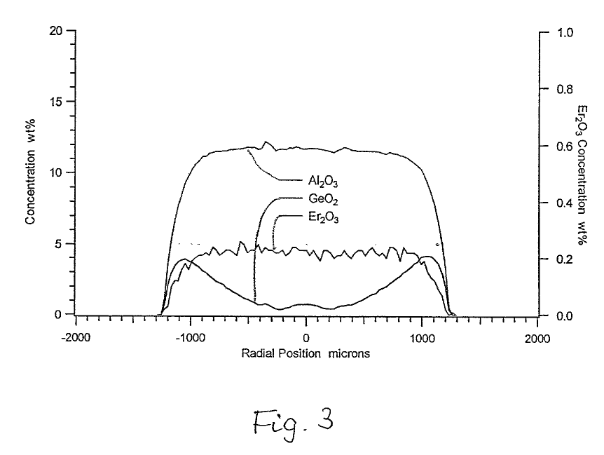

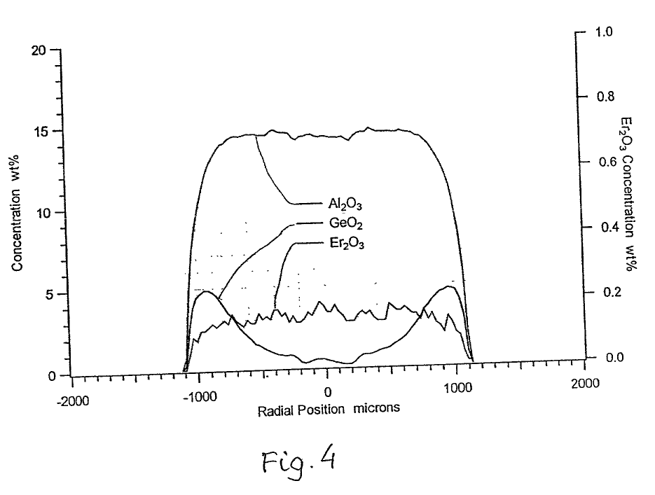

FIGS. 3 and 4 are concentration profiles where the silica layer has been deposited using a 15 and 25 sccm carrier flow rate through the SiCl₄ respectively. The silica layer thickness depends upon the inside diameter of the tube at the time of deposition. The estimated cross sectional area of silica deposited is 6.0×10⁻⁴ and 1.0×10⁻³ cm² respectively for the two flow rates. Assuming the tube inside diameter is around 6 mm, the silica layer thickness is estimated to be approximately 6 and 10 μm respectively. The length of the preform tube is practically of no importance for the purpose of this invention. A useful range of silica layer thickness is estimated to be between 5 and 20 μm. The deposition conditions were: tube temperature=1950° C., burner traverse speed=100 mm/min, inside tube pressure=2-3 mbar.

FIGS. 3 and 4, representing actual tests, show that the alumina and erbium concentration profiles were not adversely affected. In fact, they seem to be unaffected by the presence of the silica layer, although the layer does provide for a stiffer (less viscous) glass during collapse. The germania profile is somewhat affected in that it has a different profile across the core radius, but still displays the characteristic dip in the central index.

It can be speculated that the erbium and aluminum dopants diffuse into the silica layer, or another protective layer of the invention, during the subsequent collapse passes. Although this would tend the reduce the viscosity of the silica layer, it appparently provides for enough control to allow for substantial improvement of the core roundness.

The viscosity of the deposited protective silica layer may likely be even higher if the silica material has a high —OH (hydroxyl group) content. High —OH content glass is much stiffer (less viscous) than low —OH content glass. High —OH incorporation is typically undesirable since it causes optical loss at particular wavelengths, but it may be possible to decrease the silica layer thickness, increase the viscosity by —OH incorporation and still mitigate the optical loss effect depending upon how much of the core contains —OH groups.

The thickness of the protective layer is a matter of some routine experimentation as several factors can play a role here. In the experiments described below, the thickness was in the range of 5-20 μm, but as described herein, some factors (e.g. hydroxyl group content, inside diameter of the perform tube, etc.) may influence the selection. One general guide is that the thickness and properties of the protective layer should preferably be such as to avoid a significant refractive index “dip” (rapid reduction of the refractive index profile) or non-uniform dopant distribution.

It will be understood that the examples described and illustrated above are not intended to limit the invention. As well known to those skilled in the art, the specific conditions and parameters of the process of making the preform tube (with the innermost silica layer of the invention) and the subsequent operations of collapsing the tube and fiber-drawing, must be carefully selected and controlled to suit the specific application.

Accordingly, those familiar with the art may conceive of various alternatives, modifications, embodiments or variations of the above, all of which are intended to fall within the scope of the invention as defined in the appended claims.

1. A method of producing an optical fiber preform comprising an inner core region and an outer cladding region, the method comprising
a) providing a fiber preform tube predominantly of silica, the tube having an inner core zone of a core material and an outer cladding zone, the inner zone defining an inner surface of the tube, the core material comprising at least one dopant selected from the group consisting of aluminum oxide, germanium oxide and erbium oxide, and
b) depositing a protective layer of a light-transmissive material of higher viscosity than the core material, on the inner surface of the preform tube over the core material.

2. The method of claim 1 wherein the at least one dopant is erbium oxide.

3. The method of claim 1 wherein the at least one dopant is aluminum oxide.

4. The method of claim 1 wherein the step b) is effected by modified chemical vapor deposition.

5. The method of claim 1 further comprising the step of controlled heating of the preform tube after step b) to effect a collapse of the preform tube.

6. A method of manufacturing an optical fiber from a preform based on silica, the method comprising the steps of, in sequence:
providing a fiber preform tube predominantly of silica, the tube having an inner zone and an outer zone, the inner zone defining an inner surface of the tube, the inner zone comprising at least one dopant selected from the group consisting of aluminum oxide, germanium oxide and erbium oxide,
depositing at least one layer of a silica-based material on the inner surface of the tube over the doped inner zone of the preform tube,
controllably heating the preform tube to create a preform with a reduced diameter compared to the preform tube, and hot-drawing fiber from the preform.

7. An optical fiber preform tube based on silica and comprising an inner core zone and an outer cladding zone, the inner zone being of a light-transmissive core material comprising at least one dopant selected from the group consisting of aluminum oxide, germanium oxide and erbium oxide, wherein the tube further comprises a protective layer of a light-transmissive material of a viscosity higher than the viscosity of the core material, contiguous with and disposed concentrically inside the inner zone of the tube.

8. The preform tube of claim 7 wherein the at least one dopant is alumina.

9. The preform tube of claim 7 wherein the material of the protective layer is predominantly silica

10. The preform tube of claim 7 wherein the thickness of the protective layer is such as to at least alleviate viscosity-reducing effect of the at least one dopant during a thermal treatment of the preform tube.

11. The preform tube of claim 8 wherein the thickness of the protective layer is such as to at least alleviate viscosity-reducing effect of alumina during a thermal treatment of the preform tube.

12. The preform tube of claim 7 wherein the thickness of the protective layer is such as to avoid or minimize occurrence of a rapid reduction of the refractive index of the core material.

13. The preform tube of claim 9 wherein the thickness of the protective layer is in a range of 5 to 20 μm.

14. The preform tube of claim 7 wherein the protective layer is the innermost layer of the preform tube.
